(19) United States
(12) Patent Application Publication
(10) Pub. No.: US 2012/0044730 A1
(43) Pub. Date: Feb. 23, 2012

(54) LINE AND NEUTRAL POINT CLAMPED INVERTER

(75) Inventors: Mikko Paakkinen, Vantaa (FI); Matti T. Jussila, Vantaa (FI)

(73) Assignee: ABB Oy, Helsinki (FI)

(21) Appl. No.: 13/208,995

(22) Filed: Aug. 12, 2011

(30) Foreign Application Priority Data
Aug. 18, 2010 (EP) 10173154.5

(51) Int. Cl. H02M 7/537

(52) U.S. Cl. 363/131

(57) ABSTRACT

Exemplary embodiments are directed to an inverter and a method for controlling an inverter. The inverter includes a DC link having two capacitor units in series and a neutral point between the capacitor units, and a first and a second inverter leg. Both inverter legs are connected between the poles of the DC link and include four switching devices connected in series. Both inverter legs include an upper connection point between the two topmost switching devices, a lower connection point between the two bottommost switching devices, and an output between the two middle switching devices. Both inverter legs further include a first rectifier device connected between the DC link neutral point and the leg upper connection point, and a second rectifier device connected between the DC link neutral point and the leg lower connection point. Both inverter legs further include a third rectifier device connected between the upper connection point of the leg and the output of the other leg, and a fourth rectifier device connected between the output of the leg and the lower connection point of the other leg.

### RELATED APPLICATION

This application claims priority under 35 U.S.C. §119 to European Patent Application No. 10173154.5 filed in Europe on Aug. 18, 2010, the entire content of which is hereby incorporated by reference in its entirety.

### FIELD

The present disclosure relates to inverter topologies, such as a solar inverter topology for supplying a grid.

### BACKGROUND INFORMATION

A solar inverter is used to convert a DC voltage produced by solar cells into an AC voltage with high efficiency. Known generic inverter can use 2-level (line-to-neutral) topology, where an output is tied either to the positive pole or the negative pole of a DC link. The efficiency can be increased by using a 3-level (line-to-neutral) topology, where the output can be tied to three potentials: positive or negative pole of the DC link or a neutral point.

A solar inverter can also be used to minimize high-frequency common-mode voltages between the DC link and the protective ground. When these high-frequency common-mode voltages are present, high-frequency common-mode currents may flow through parasitic capacitances of the photovoltaic panels and possibly damage the photovoltaic panels. The minimizing of the common-mode voltage can therefore be important in photovoltaic inverter applications.

The publication A new neutral-point-clamped PWM inverter, A. Nabae, I. Takahashi, & H. Akagi discloses an NPC (Neutral Point Clamped) describes an inverter topology which can be used to minimize the generation of the harmful high-frequency common-mode voltage. The NPC inverter uses 3-level (line-to-neutral) modulation and can have 5-level (line-to-line) output voltage, where the output voltage is measured between two output lines.

To avoid the common-mode voltage, a “neutral point zero state” (zero state) can be used in the NPC inverters. In a zero state, the output lines have no connection to the DC link. In addition, the outputs can be tied to the same potential, which is the neutral point, in a neutral point zero state. The outer switches in the inverter legs are in a non-conducting state and the current flows through two inner switches and two diodes.

By using the neutral point zero state and 3-level (line-to-line) output, voltage generation the common-mode voltage can be eliminated. The use of a 3-level (line-to-neutral) modulation also increases efficiency compared to a 2-level (line-to-neutral) modulation.

However, one of the disadvantages associated with the above arrangement is that there are always four power semiconductors on the route of the current. These power semiconductors on the route of the current increase power losses.

### SUMMARY

An exemplary inverter for supplying a grid is disclosed. The inverter comprising a DC link including two capacitor units in series and a neutral point (V_{DC0}) between the capacitor units, and a first and a second inverter leg, wherein both inverter legs are connected between the poles (V_{DC+} and V_{DC-}) of the DC link and both inverter legs comprising four switching devices (Sₙ₁-Sₙ₄) connected in series, wherein each switch has a conductive state and a non-conductive state and the switches together forming a low resistance route from the positive pole of the DC link to the negative pole of the DC link when all are in the conducting state, an upper connection point (Vₙ₁₂) between two topmost switching devices (Sₙ₁, Sₙ₂) of the four switching devices, a lower connection point (Vₙ₃₄) between two bottommost switching devices (Sₙ₃, Sₙ₄) of the four switching devices, an output (Vₙ₂₃) between two middle switching devices (Sₙ₂, Sₙ₃) of the four switching devices, a first rectifier device (Dₙ₁) connected between a neutral point (V_{DC0}) of the DC link and an upper connection point (Vₙ₁₂) of the leg allowing flow of current from the DC link neutral point (V_{DC0}) to the upper connection point (Vₙ₁₂), and a second rectifier device (Dₙ₂) connected between the DC link neutral point (V_{DC0}) and a lower connection point (Vₙ₃₄) of the leg allowing flow of current from the lower connection point (Vₙ₃₄) to the DC link neutral point (V_{DC0}), wherein each inverter leg further comprises a third rectifier device (Dₙ₃) connected the between upper connection point (Vₙ₁₂) of the leg and an output (Vₘ₂₃) of the other leg allowing flow of current from the output (Vₘ₂₃) of the other leg to the upper connection point (Vₙ₁₂), and a fourth rectifier device (Dₙ₄) connected between the output (Vₘ₂₃) of the other leg and the lower connection point (Vₙ₃₄) of the leg allowing flow of current from the lower connection point (Vₙ₃₄) to the output (Vₘ₂₃) of the other leg.

An exemplary method for controlling an inverter having a DC link including two capacitor units in series and a neutral point (V_{DC0}) between the capacitor units, and a first and a second inverter leg, wherein both inverter legs are connected between the poles (V_{DC+} and V_{DC-}) of the DC link and both inverter legs comprising four switching devices (Sₙ₁-Sₙ₄) connected in series, wherein each switch has a conductive state and a non-conductive state and the switches together forming a low resistance route from the positive pole of the DC link to the negative pole of the DC link when all are in the conducting state, an upper connection point (Vₙ₁₂) between two topmost switching devices (Sₙ₁, Sₙ₂) of the four switching devices, a lower connection point (Vₙ₃₄) between two bottommost switching devices (Sₙ₃, Sₙ₄) of the four switching devices, an output (Vₙ₂₃) between two middle switching devices (Sₙ₂, Sₙ₃) of the four switching devices, a first rectifier device (Dₙ₁) connected between a neutral point (V_{DC0}) of the DC link and an upper connection point (Vₙ₁₂) of the leg allowing flow of current from the DC link neutral point (V_{DC0}) to the upper connection point (Vₙ₁₂), and a second rectifier device (Dₙ₂) connected between the DC link neutral point (V_{DC0}) and a lower connection point (Vₙ₃₄) of the leg allowing flow of current from the lower connection point (Vₙ₃₄) to the DC link neutral point (V_{DC0}), wherein each inverter leg further comprises a third rectifier device (Dₙ₃) connected the between upper connection point (Vₙ₁₂) of the leg and an output (Vₘ₂₃) of the other leg allowing flow of current from the output (Vₘ₂₃) of the other leg to the upper connection point (Vₙ₁₂), and a fourth rectifier device (Dₙ₄) connected between the output (Vₘ₂₃) of the other leg and the lower connection point (Vₙ₃₄) of the leg allowing flow of current from the lower connection point (Vₙ₃₄) to the output (Vₘ₂₃) of the other leg is disclosed. The method comprising setting one or more of the middle switching devices to conducting state so that the inverter is set to a neutral point zero state.

An exemplary inverter for supplying a grid is disclosed. The inverter comprising a DC link including two capacitor units in series and a neutral point (V_{DC0}) between the capacitor units, and a first and a second inverter leg, wherein both inverter legs are connected between the poles of the DC link. Each inverter leg comprising four switching devices connected in series and the switches together form a low resistance route from the positive pole of the DC link to the negative pole of the DC link, a first rectifier device connected between a neutral point of the DC link and an upper connection point of the leg allowing flow of current from the DC link neutral point to the upper connection point, and a second rectifier device connected between the DC link neutral point and a lower connection point of the leg allowing flow of current from the lower connection point to the DC link neutral point. Each inverter leg also comprises a third rectifier device connected the between upper connection point of the leg and an output of the other leg allowing flow of current from the output of the other leg to the upper connection point, and a fourth rectifier device connected between the output of the other leg and the lower connection point of the leg allowing flow of current from the lower connection point to the output of the other leg.

### BRIEF DESCRIPTION OF THE DRAWINGS

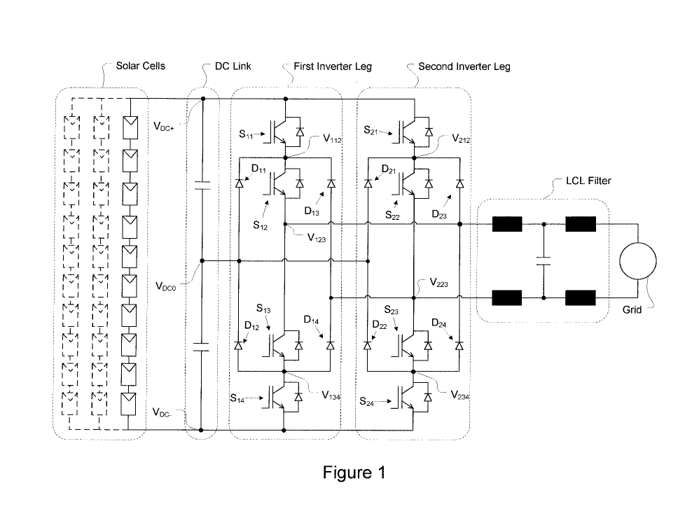

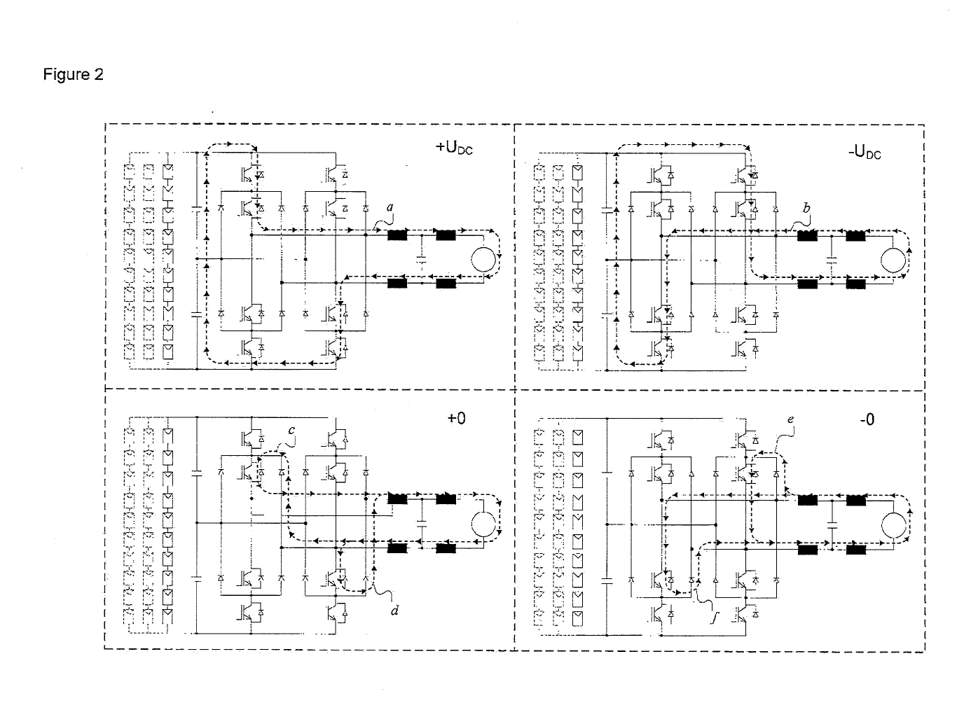

In the following the disclosure will be described in greater detail by means of preferred embodiments with reference to the attached drawings, in which FIG. 1 illustrates a simplified diagram of an inverter according to an exemplary embodiment; and FIG. 2 illustrates the paths for currents in an embodiment according to an exemplary embodiment.

### DESCRIPTION OF THE DRAWINGS

FIG. 1 illustrates a simplified diagram of an inverter according to an exemplary embodiment; and

FIG. 2 illustrates the paths for currents in an embodiment according to an exemplary embodiment.

### DETAILED DESCRIPTION

Exemplary embodiments of the present disclosure provide new paths for current in the neutral point zero state. Routes with only two power semiconductors can be established by clamping the inverter legs also from the line side. The power losses thus decrease and better efficiency can be achieved.

FIG. 1 illustrates a simplified diagram of an inverter according to an exemplary embodiment. The inverter supplies a grid and includes a DC link, having two capacitor units in series and a neutral point V_{DC0} between the capacitor units. As shown FIG. 1, power to the DC link is supplied by solar cells. The DC link can also be supplied by other types of power sources. The power source can be a fuel cell, a rechargeable battery bank or a boost converter. The converter can also have a galvanic isolation between its input and output.

The inverter further includes a first inverter leg and a second inverter leg, both legs being connected between the poles V_{DC+} and V_{DC-} of the DC link. Both inverter legs have four switching devices Sₙ₁-Sₙ₄ (nε{1,2}) connected in series. Each switching device Sₙ₁-Sₙ₄ has a conducting state and a non-conducting state and the switching devices Sₙ₁-Sₙ₄ together form a low resistance route from the positive pole of the DC link to the negative pole of the DC link when all switching devices Sₙ₁-Sₙ₄ are in the conducting state. The switching devices Sₙ₁-Sₙ₄ can be, for example, IGBTs or power MOSFETs or any other suitable switching device as desired. In an exemplary embodiment, each switching device S₁₁-S₁₄ and S₂₁-S₂₄ is paired with a freewheeling diode. In other exemplary embodiments of the present disclosure, some of the switching devices may be IGBTs and some power MOSFETs.

Both inverter legs can include an upper connection point Vₙ₁₂ between the two topmost switching devices Sₙ₁ and Sₙ₂, a lower connection point Vₙ₃₄ between the two bottommost switching devices Sₙ₃ and Sₙ₄, and an output Vₙ₂₃ between the two middle switching devices Sₙ₂ and Sₙ₃. The output can be filtered with a balanced LCL filter.

The inverter legs can be clamped to the neutral point V_{DC0}. For example, both inverter legs include a first rectifier device Dₙ₁ which is connected between the DC link neutral point V_{DC0} and the leg upper connection point Vₙ₁₂ allowing flow of current from the DC link neutral point V_{DC0} to the leg upper connection point Vₙ₁₂, and a second rectifier device Dₙ₂ connected between the DC link neutral point V_{DC0} and the leg lower connection point Vₙ₃₄ allowing flow of current from the leg lower connection point Vₙ₃₄ to the DC link neutral point V_{DC0}. The first rectifier device Dₙ₁ and second rectifier Dₙ₂ device tie the output Vₙ₂₃ of each inverter leg to the neutral point in the neutral point zero state.

The inverter legs can also be clamped from the output line side. For example, both inverter legs include a third rectifier Dₙ₃ device connected between the upper connection point Vₙ₁₂ of the leg and the output Vₘ₂₃ (Mε{1,2}, m≠n) of the other leg allowing flow of current from the output Vₘ₂₃ of the other leg to the leg upper connection point Vₙ₁₂, and a fourth rectifier device Dₙ₄ connected between the output Vₘ₂₃ of the other leg and the lower connection point Vₙ₃₄ of the leg allowing flow of current from the lower connection point Vₙ₃₄ to the output Vₘ₂₃ of the other leg.

The third rectifier Dₙ₃ and fourth rectifier Dₙ₄, in cooperation with the inverter leg middle switches Sₙ₂ and Sₙ₃, provide a path for current which has only two power semiconductors: a diode Dₙ₃ or Dₙ₄ and a switch Sₙ₂ or Sₙ₃, respectively.

Table 1 below illustrates a 3-level (line-to-line) output voltage modulation scheme for an embodiment according to the present invention. The scheme has five switching states: +U_{DC}, +0, ±0, −0 and −U_{DC}, represented in Table 1 by five main columns labelled respectively. The rows of the table represent the states of the individual switches where “1” stands for the conducting state and “0” for the non-conducting state.

TABLE 1
A modulation scheme for an exemplary embodiment

| | +U_{DC} | +0 | ±0 | −0 | −U_{DC} |
|---|---|---|---|---|---|
| S₁₁ | 1 | 0 | 0 | 0 | 0 |
| S₁₂ | 1 | 1 | 1 | 0 | 0 |
| S₁₃ | 0 | 0 | 1 | 1 | 1 |
| S₁₄ | 0 | 0 | 0 | 0 | 1 |
| S₂₁ | 0 | 0 | 0 | 0 | 1 |
| S₂₂ | 0 | 0 | 1 | 1 | 1 |
| S₂₃ | 1 | 1 | 1 | 0 | 0 |
| S₂₄ | 1 | 0 | 0 | 0 | 0 |

The voltage between the inverter leg outputs can in this modulation scheme be set to three potentials: +U_{DC}, 0 and −U_{DC}, where U_{DC} is the voltage potential of the DC link and 0 is zero potential. Each of these potentials can be formed without changes in common-mode voltage.

The potentials +U_{DC} and −U_{DC} can be formed by using states +U_{DC} and −U_{DC}, respectively. The upmost switching devices Sₙ₁ and Sₙ₂ of an inverter leg and the two bottommost switching devices Sₙ₃ and Sₙ₄ of the other inverter leg are set to a conducting state, as shown in Table 1. The switching devices provide a path for current from the DC link to the grid. FIG. 2 illustrates the paths for currents in an embodiment according to an exemplary embodiment. In FIG. 2, a section denoted with +U_{DC} illustrates the route a for current in the state +U_{DC}. Similarly, a section denoted with −U_{DC} illustrates the route b for current in the state −U_{DC}.

The zero potential 0 is formed using one of three neutral point zero states +0, ±0 or −0. The state +0 provides two paths for current in the same direction as in state +U_{DC}. The routes c and d for current in the state +0 are illustrated in section +0 of FIG. 2. In a similar manner, the state −0 provides two paths for current in the same direction as in state −U_{DC}. The routes e and f for current in the state −0 are illustrated in section −0 of FIG. 2. The state ±0 provides the same paths c, d, e and f as states +0 and −0 together.

Neutral point zero states can also be formed with one path for current. In a zero state, a neutral point zero state with one current path (c, d, e or f) can be formed by setting only one of the middle switching devices S₁₂, S₁₃, S₂₂ or S₂₃ to a conducting state.

In other exemplary embodiments, various combinations of routes for current in the neutral point zero state are also possible. For instance, both middle switching devices of an inverter leg may be set to a conducting state. The leg thus provides routes to both directions of current.

In an exemplary embodiment, the DC link of an inverter is supplied by a switching converter with galvanic isolation, modulation methods with 5-level output voltage (line-to-line) can be used because the galvanic isolation can effectively prevent the common-mode voltages from advancing to the grid side.

In other exemplary embodiments, various modulation methods and switching combinations can be used to control an inverter according to the present disclosure.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. An inverter for supplying a grid, comprising:
a DC link including two capacitor units in series and a neutral point between the capacitor units; and
a first and a second inverter leg, wherein both inverter legs are connected between the poles of the DC link; wherein each inverter leg comprises:
four switching devices connected in series, wherein each switch has a conductive state and a non-conductive state and the switches together forming a low resistance route from the positive pole of the DC link to the negative pole of the DC link when all are in the conducting state;
an upper connection point between two topmost switching devices of the four switching devices;
a lower connection point between two bottommost switching devices of the four switching devices;
an output between two middle switching devices of the four switching devices;
a first rectifier device connected between a neutral point of the DC link and an upper connection point of the leg allowing flow of current from the DC link neutral point to the upper connection point;
a second rectifier device connected between the DC link neutral point and a lower connection point of the leg allowing flow of current from the lower connection point to the DC link neutral point;
a third rectifier device connected the between upper connection point of the leg and an output of the other leg allowing flow of current from the output of the other leg to the upper connection point; and
a fourth rectifier device connected between the output of the other leg and the lower connection point of the leg allowing flow of current from the lower connection point to the output of the other leg.

2. The inverter of claim 1, wherein the switching devices are IGBTs or power MOSFETs.

3. The inverter according to claim 1, wherein at least once of the switching devices are IGBTs and at least one of the switching devices are power MOSFETs.

4. The inverter of claim 1, wherein the DC link of the inverter is supplied by a switching converter, which has a galvanic isolation between its input and output.

5. The inverter according to claim 1, wherein that the DC link of the inverter is supplied by a solar generator.

6. The inverter according to claim 1, wherein the DC link of the inverter is supplied by fuel cells.

7. The inverter according to claim 1, wherein the DC link of the inverter is supplied by a rechargeable battery or a rechargeable battery bank.

8. The inverter according to claim 1, wherein the DC link of the inverter is supplied by a boost converter.

9. The inverter according to claim 1, wherein each switching device is paired with a freewheeling diode.

10. A method for controlling an inverter according to claim 1, wherein that the method comprising:
setting one or more of the middle switching devices to conducting state so that the inverter is set to a neutral point zero state.

11. The method according to claim 10, wherein that the method comprises:
setting the inverter to a neutral point zero state where the current has one path.

12. The method according to claim 10, wherein the method uses switching states that have same common-mode voltage.

13. An inverter for supplying a grid, comprising:
a DC link including two capacitor units in series and a neutral point between the capacitor units; and
a first and a second inverter leg, wherein both inverter legs are connected between the poles of the DC link. wherein each inverter leg comprises:
four switching devices connected in series and the switches together form a low resistance route from the positive pole of the DC link to the negative pole of the DC link;
a first rectifier device connected between a neutral point of the DC link and an upper connection point of the leg allowing flow of current from the DC link neutral point to the upper connection point;
a second rectifier device connected between the DC link neutral point and a lower connection point of the leg allowing flow of current from the lower connection point to the DC link neutral point;
a third rectifier device connected the between upper connection point of the leg and an output of the other leg allowing flow of current from the output of the other leg to the upper connection point; and
a fourth rectifier device connected between the output of the other leg and the lower connection point of the leg allowing flow of current from the lower connection point to the output of the other leg.

14. The inverter of claim 13, wherein, the upper connection point is between two topmost switching devices of the four switching devices;

15. The inverter of claim 13, wherein the lower connection point between two bottommost switching devices of the four switching devices.

16. The inverter of claim 13, wherein the output is between two middle switching devices of the four switching devices.

17. The inverter of claim 13, wherein each switch has a conductive state and a non-conductive state.
